(19) United States
(12) Patent Application Publication
(10) Pub. No.: US 2024/0394969 A1
(43) Pub. Date: Nov. 28, 2024

(54) MODEL PROCESSING METHOD AND APPARATUS, DEVICE, AND MEDIUM

(71) Applicant: Beijing Zitiao Network Technology Co., Ltd., Beijing (CN)

(72) Inventors: Bo YUAN, Beijing (CN); Can WANG, Beijing (CN); Ze WANG, Beijing (CN); Haishan LIU, Beijing (CN); Shaoyuan LI, Beijing (CN)

(21) Appl. No.: 18/696,907

(22) PCT Filed: Sep. 29, 2022
(86) PCT No.: PCT/CN2022/122434

§ 371 Date: Mar. 28, 2024

(30) Foreign Application Priority Data
Oct. 8, 2021 (CN) 202111172577.7

(51) Int. Cl. G06T 17/00; G06T 15/00; G06T 19/20

(52) U.S. Cl. CPC G06T 17/00; G06T 15/005; G06T 19/20; G06T 2219/2016

(57) ABSTRACT

A method and apparatus, a device, and a medium for model processing is provided. The model processing method includes in response to a photographing instruction for a target object in a virtual three-dimensional scene, obtaining a two-dimensional image of the target object, and storing the two-dimensional image in a specified position; wherein the target object is a three-dimensional model located in a first position in the virtual three-dimensional scene; obtaining an initial model parameter of the target object; and in response to a three-dimensional restoration instruction for the two-dimensional image stored in the specified position, restoring the target object in a second position in the virtual three-dimensional scene according to the three-dimensional restoration instruction and the initial model parameter, and wherein the three-dimensional restoration instruction is used for indicating the second position.

### CROSS-REFERENCE TO RELATED APPLICATIONS

This application claims priority of the Chinese Patent Application filed with the China Patent Office on Oct. 8, 2021, with the application No. 202111172577.7 and entitled “Model Processing Method and Apparatus, Device and Medium”, the disclosure of which is incorporated herein by reference in its entirety.

### TECHNICAL FIELD

The present disclosure relates to a field of data processing technology, and more particularly, to a model processing method and apparatus, a device and a medium.

### BACKGROUND

In application scenes such as three-dimensional (3D) games, Augmented Reality (AR), Virtual Reality (VR), etc., it may be necessary to involve reconstruction of a three-dimensional model, such as constructing a corresponding three-dimensional model based on an existing two-dimensional image; however, the existing methods are time-consuming and inefficient when reconstructing models.

### SUMMARY

In order to solve the above-described technical problems or at least partially solve the above-described technical problems, the present disclosure provides a model processing method and apparatus, a device and a medium.

The embodiments of the present disclosure provide a model processing method, the method comprising:
in response to a photographing instruction for a target object in a virtual three-dimensional scene, obtaining a two-dimensional image of the target object, and storing the two-dimensional image in a specified position; wherein the target object is a three-dimensional model located in a first position in the virtual three-dimensional scene; obtaining an initial model parameter of the target object; and in response to a three-dimensional restoration instruction for the two-dimensional image stored in the specified position, restoring the target object in a second position in the virtual three-dimensional scene according to the three-dimensional restoration instruction and the initial model parameter, wherein the three-dimensional restoration instruction is used for indicating the second position.

Alternatively, the step of obtaining the two-dimensional image of the target object, comprises: performing a two-dimensional projection on the target object according to a specified photographing parameter, to obtain the two-dimensional image of the target object.

Alternatively, the step of obtaining the initial model parameter of the target object, comprises: obtaining a parameter of the three-dimensional model presented by the target object within a photographing angle range of view corresponding to the photographing parameter, through a spatial acceleration structure and/or a view frustum culling mode; and taking the obtained parameter of the three-dimensional model as the initial model parameter of the target object.

Alternatively, the step of restoring the target object in the second position in the virtual three-dimensional scene according to the three-dimensional restoration instruction and the initial model parameter, comprises: restoring the target object in the second position in the virtual three-dimensional scene according to the three-dimensional restoration instruction, the photographing parameter, and the initial model parameter.

Alternatively, the three-dimensional restoration instruction is further used for indicating a restoration shape of the target object.

Alternatively, the three-dimensional restoration instruction is generated according to steps of: when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and generating the three-dimensional restoration instruction based on the user operations.

Alternatively, the step of generating the three-dimensional restoration instruction based on the user operations, comprises: when the user operations comprise the move operation, determining a final movement position of the two-dimensional image in the three-dimensional virtual scene according to the move operation; when the user operations comprise the rotate operation, determining a final space angle of the two-dimensional image in the three-dimensional virtual scene according to the rotate operation; when the user operations comprise the scale operation, determining a final size of the two-dimensional image in the three-dimensional virtual scene according to the scale operation; and generating the three-dimensional restoration instruction according to one or more of the determined final movement position, the final space angle, and the final size.

Alternatively, the step of restoring the target object in the second position in the virtual three-dimensional scene, according to the three-dimensional restoration instruction, the photographing parameter, and the initial model parameter, comprises: drawing a restored model of the target object by using GPU, according to the restoration shape, the photographing parameter, and the initial model parameter; and placing the restored model of the target object in the second position in the virtual three-dimensional scene.

Alternatively, the step of drawing a restored model of the target object by using GPU, according to the restoration shape, the photographing parameter, and the initial model parameter, comprises: determining a culling boundary and material parameter of the restored model of the target object, according to the restoration shape, the photographing parameter, and the initial model parameter; and drawing the restored model of the target object by using GPU Shader based on the culling boundary and the material parameter.

Alternatively, the method further comprises in response to an interaction instruction for the target object located in the second position, executing an operation corresponding to the interaction instruction.

The embodiments of the present disclosure further provide a model processing apparatus, comprising: an image obtaining module, utilized to in response to a photographing instruction for a target object in a virtual three-dimensional scene, obtain a two-dimensional image of the target object, and store the two-dimensional image in a specified position; wherein the target object is a three-dimensional model located in a first position in the virtual three-dimensional scene; a parameter obtaining module, utilized to obtain an initial model parameter of the target object; and a restoring module, utilized to in response to a three-dimensional restoration instruction for the two-dimensional image stored in the specified position, restore the target object in a second position in the virtual three-dimensional scene according to the three-dimensional restoration instruction and the initial model parameter, and wherein the three-dimensional restoration instruction is used for indicating the second position.

The embodiments of the present disclosure further provide an electronic device, the electronic device comprising: a processor; a memory, utilized to store processor executable instructions; the processor, utilized to read the executable instructions from the memory, and execute the instructions to implement the model processing method provided by the embodiments of the present disclosure.

The embodiments of the present disclosure further provide a computer readable storage medium, having a computer program stored thereon, wherein the computer program is configured to execute the model processing method provided by the embodiments of the present disclosure.

In the above-described technical solutions provided by the embodiments of the present disclosure, in response to a photographing instruction for a target object in a virtual three-dimensional scene, a two-dimensional image of the target object may be obtained and stored in a specified position; wherein the target object is a three-dimensional model located in a first position in the virtual three-dimensional scene; thereafter, an initial model parameter of the target object may be obtained; and finally, in response to a three-dimensional restoration instruction (which may indicate the second position) for the two-dimensional image stored in the specified position, the target object may be restored in the second position of the virtual three-dimensional scene according to the three-dimensional restoration instruction and the initial model parameter. In the above-described mode, the existing 3D model may undergo 2D transformation (i.e., be transformed into an image), and further the image is inversely restored to the 3D model based on the three-dimensional restoration instruction and the initial model parameter, so that rapid and efficient model restoration may be performed on an interested target object in different positions.

It should be understood that the content described in the section is not intended to identify key or important features of the embodiments of the present disclosure, nor is it used to limit the scope of the present disclosure. Other features of the present disclosure will be easily understood through the specification below.

### BRIEF DESCRIPTION OF THE DRAWINGS

The accompanying drawings here are incorporated into the specification and form a part of this specification, showing embodiments that comply with the present disclosure and are used together with the specification to explain the principles of the present disclosure.

In order to clearly illustrate the technical solution of the embodiments of the present disclosure or in the prior art, the drawings that need to be used in the description of the embodiments or the prior art will be briefly described in the following; it is obvious that based on the drawings, those ordinarily skilled in the art can obtain other drawings, without any inventive work.

FIG. 1 is a schematic flow chart of a model processing method provided by one embodiment of the present disclosure;

FIG. 2 is a schematic diagram of a view frustum provided by one embodiment of the present disclosure;

FIG. 3a to FIG. 3e are all schematic diagrams of a virtual three-dimensional scene provided by one embodiment of the present disclosure;

FIG. 4 is a schematic flow chart of another model processing method provided by one embodiment of the present disclosure;

FIG. 5 is a structural schematic diagram of a model processing apparatus provided by an embodiment of the present disclosure; and

FIG. 6 is a structural schematic diagram of an electronic device provided by one embodiment of the present disclosure.

### DETAILED DESCRIPTION

To understand the above objects, features, and advantages of the present disclosure more clearly, the scheme of the present disclosure will be further described below. It should be noted that the embodiments of the present disclosure and the features in the embodiments can be combined with each other without conflict.

In the following description, many specific details are outlined to fully understand the present disclosure, but the present disclosure may be practiced in other ways than those described herein; obviously, the embodiments in the specification are only part of the embodiments of the present disclosure, not all of them.

In the existing application scenes such as 3D games, AR, VR, etc., it is usually necessary to reconstruct a 3D model based on an existing 2D picture, in which case the 2D picture is restored to the 3D model or a point cloud mostly by using a deep learning algorithm; however, it takes a lot of time to run the neural network, which is time-consuming and inefficient and has low accuracy. Or, in some related technologies, an association relationship between 2D pictures and 3D models will be established and stored in advance, that is, each 2D picture is fixedly associated with a 3D model, but in such mode, reconstruction is only applicable to a 3D model under a fixed angle of view corresponding to an existing picture, which is less flexible. To improve at least one of the above-described problems, the embodiments of the present disclosure provide a model processing method and apparatus, a device, and a medium, which will be described in detail below:

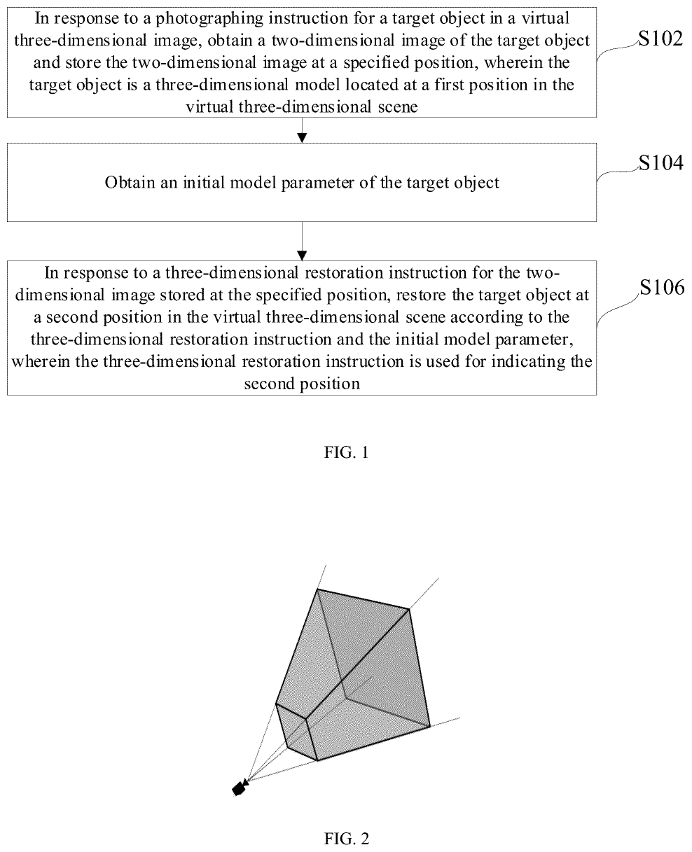

FIG. 1 is a schematic flow chart of a model processing method provided by an embodiment of the present disclosure; the method may be executed by a model processing apparatus, wherein the apparatus may be implemented through software and/or hardware, and may usually be integrated into an electronic device. As shown in FIG. 1, the method mainly comprises step S102 to step S106 as follows:

Step S102, in response to a photographing instruction for a target object in a virtual three-dimensional image, obtain a two-dimensional image of the target object and store the two-dimensional image at a specified position, wherein the target object is a three-dimensional model located at a first position in the virtual three-dimensional scene.

For ease of understanding, a specific application example is given below: a user may roam in a virtual three-dimensional scene, and when encountering an interested target object, the user photographs the same through a virtual photographing camera to obtain a two-dimensional image (which may also refer to as a picture) of the target object. In practical use, any target object may be selected according to preferences for photographing, or it may also be understood that a picture may be taken according to preferences, and the content in the picture is the target object; the target object will not be limited in the embodiment of the present disclosure, for example, the target object may be a person, an object, or even a portion of an object, such as a branch of a tree, a portion of a bridge, etc.; any component included in the virtual three-dimensional scene may be taken as the target object, that is, the target object is also a three-dimensional model and an initial position of the target object in the virtual three-dimensional scene is the above-described first position.

In practical use, the user may initiate a photographing instruction for the target object through a gesture, finger touch, an external control device (e.g., a mouse, a keyboard, a console, etc.), or the like; the electronic device executing the model processing method may determine the target object based on the photographing instruction and obtain a two-dimensional image of the target object after monitoring the photographing instruction of the user. In some implementations, the two-dimensional image is obtained by projecting the target object as the three-dimensional model in a specified mode; the specified mode may be determined based on the photographing instruction; for example, the photographing instruction carries information about the specified mode, exemplarily, the photographing instruction carries a photographing parameter. On this basis, in some implementations, the step of obtaining a two-dimensional image of the target object comprises: performing a two-dimensional projection on the target object according to a specified photographing parameter, to obtain the two-dimensional image of the target object. The photographing parameter also indicates a projection mode (or may also be understood as a rendering mode) for transforming the three-dimensional model of the target object into the two-dimensional image.

For ease of understanding, still taking the virtual photographing camera as an example, a photographing parameter is just a camera parameter of the photographing camera; when using the photographing camera to photograph the target object, the user may set the camera parameter according to needs; the camera parameter includes but are not limited to one or more types such as focal length, focal point, photographing angle of view or field of view, aspect ratio, camera pose, etc.; and then, the target object is photographed based on the camera parameter, to obtain the two-dimensional image.

To facilitate subsequent applications, the two-dimensional image may be stored in a specified position; for example, taking a game scenario as an example, the user may store the two-dimensional image in a position such as a game card pack or a toolbox (which is, storing in a storage space corresponding to a game card or a toolbox, for backend implementation of the electronic device), so that the user may directly fetch the two-dimensional image from the specified position for three-dimensional restoration when needed subsequently.

Step S104, obtain an initial model parameter of the target object.

Since the target object is a three-dimensional model in a virtual three-dimensional scene already constructed, model parameter of the virtual three-dimensional scene are already pre-stored, so the initial model parameter of the target object may also be directly obtained.

Step S106, in response to a three-dimensional restoration instruction for the two-dimensional image stored at the specified position, restore the target object at a second position in the virtual three-dimensional scene according to the three-dimensional restoration instruction and the initial model parameter, wherein the three-dimensional restoration instruction is used for indicating the second position. In a case where the initial model parameter are known, the model may be rapidly restored when needed, that is, upon receiving the three-dimensional restoration instruction indicating the second position, restoration of 2D to 3D may be implemented in the second position based on the three-dimensional restoration instruction and the initial model parameter, which may be simply understood as an inverse process of photographing (3D to 2D).

For ease of understanding, a specific application example will be given below: after photographing the target object located in the first position in the virtual three-dimensional scene, the user may continue to roam; when the user roams to the second position where the user wants to reconstruct the target object, the user may directly restore the target object in the second position in the virtual three-dimensional scene; taking the target object as a bridge, the user takes a picture in an initial position (the first position) of the bridge to obtain an image of the bridge; then, the user roams to another river without a bridge, and the user may reconstruct a three-dimensional model of the bridge on the river so that the user may cross the river through the reconstructed bridge.

The second position will not be limited in the embodiments of the present disclosure, and may be specifically determined by the user; the restored target object is still a three-dimensional model, and a placement mode and/or a shape of the three-dimensional model of the restored target object in the second position in the virtual three-dimensional scene may be the same as or different from the initial model located in the first position, depending on an angle of view; a photographing angle of view and a restoration angle of view of the model may be arbitrary, specifically depending on the user, which will not be limited in the embodiments of the present disclosure.

In summary, in the above-described model processing method provided by the embodiment of the present disclosure, the existing 3D model may undergo 2D transformation (i.e., be transformed into an image), and further, the image is inversely restored to the 3D model based on the three-dimensional restoration instruction and the initial model parameter, so that rapid and efficient model restoration may be performed on an interested target object in different positions. In addition, based on the existing initial model parameter, the above-described inverse restoration process may effectively ensure model restoration accuracy. Besides, the user may flexibly select an interested target object according to needs and may capture an image thereof and perform model restoration from an arbitrary angle of view, with more flexibility and freedom, which further improves the problems in related technologies such as poor flexibility that reconstruction is only applicable to a 3D model under a fixed angle of view corresponding to an existing picture.

In some implementations, the embodiment of the present disclosure provides an implementation of the above-described step S102, that is, the above-described step of obtaining a two-dimensional image of the target object, comprises: in response to a photographing instruction for a target object in a virtual three-dimensional scene, photographing the target object from a specified angle of view through a photographing camera, to obtain the two-dimensional image of the target object; wherein the target object and the specified angle of view are both determined based on the photographing instruction.

In practical applications, in a process of roaming/playing in the three-dimensional virtual scene, when encountering an interested target object, the user may photograph a two-dimensional image of the target object through a virtual camera, that is, perform 2D transformation on the target object. In some implementations, the user may generate a photographing instruction by manipulating the photographing camera; and content presented in a preview interface of the photographing camera is the target object; the angle of view when the user manipulates the photographing camera is the specified angle of view. It should be noted that the above-described specified angle of view is only the angle of view when the user photographs the target object with the camera and may be an arbitrary angle of view, which may be determined according to the needs of the user and will not be limited in the embodiments of the present disclosure. When obtaining the two-dimensional image through photographing, the camera parameter may be recorded simultaneously.

In some implementations, the step of obtaining the initial model parameter of the target object comprises: obtaining a parameter of the three-dimensional model presented by the target object within a photographing angle range of view corresponding to the photographing parameter through a spatial acceleration structure and/or a view frustum culling mode; and taking the obtained parameter of the three-dimensional model as the initial model parameter of the target object. As described above, a photographing parameter may be used for indicating a specific projection mode or a specific rendering mode for transforming the target object into a two-dimensional image; the photographing parameter may be understood as the camera parameter when photographing the target object with the virtual photographing camera, to obtain the two-dimensional image; the photographing parameter, for example, includes a photographing angle of view; all photographing angle of views have a certain range, that is, the above-described photographing angle range of view. It may be understood that two-dimensional images obtained by projecting the target object within different photographing angle ranges of view are different; in the embodiment of the present disclosure, the parameter of the three-dimensional model presented within the photographing angle range of view obtained here is taken as the initial model parameter of the target object.

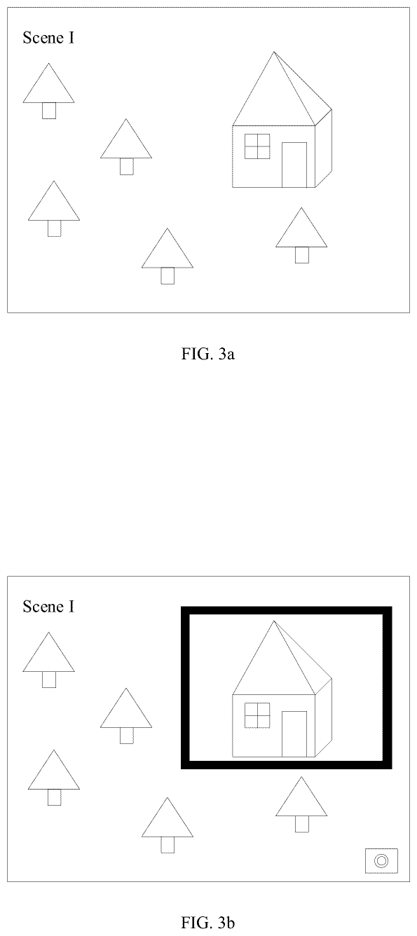

In a 3D drawing application, the spatial acceleration structure may be used for more rapidly determining geometric relationships such as intersection, inclusion, etc., of objects in the 3D scene, to implement space partitioning. Implementation of the spatial acceleration structure will not be limited to the embodiments of the present disclosure, and spatial acceleration structures such as KD-tree, uniform grid, Bounding Volume Hierarchy (BVH), etc., may be adopted for Implementation, for which related technologies may be referred to, and no details will be repeated here. The view frustum refers to a visible frustum range of the camera in the scene, which is composed of six faces: top, bottom, left, right, near, and far, for details, the schematic diagram of the view frustum shown in FIG. 2 may be referred to; scenery within the view frustum is visible, and vice versa. To improve performance, only objects having an intersection with the view frustum may be drawn; in other words, view frustum culling is a method of removing objects that are not in the view frustum without drawing, while drawing objects that are inside or intersect with the view frustum, which may improve performance of 3D drawing. In the embodiment of the present disclosure, the three-dimensional model presented by the locked target object within the photographing angle range of view corresponding to the photographing parameter may be reliably and accurately obtained through the spatial acceleration structure and/or the view frustum culling mode, to further obtain corresponding parameter thereof, which facilitates subsequent 3D drawing.

The embodiment of the present disclosure further provides an implementation of the above-described step S106, that is, the above-described step of restoring the target object in the second position in the virtual three-dimensional scene according to the three-dimensional restoration instruction and the initial model parameter, comprises: restoring the target object in the second position in the virtual three-dimensional scene, according to the three-dimensional restoration instruction, the photographing parameter, and the initial model parameter. Specifically, in some implementations, the second position is directly determined based on the three-dimensional restoration instruction, while in other implementations, the second position is determined jointly based on the three-dimensional restoration instruction and the photographing parameter. For ease of understanding, it will be exemplarily explained below:

In practical applications, in a process of roaming/playing in the three-dimensional virtual scene, the user may inversely restore the collected two-dimensional image to the three-dimensional model of the target object, that is, restore the target object, when encountering a scene where the target object is wished to be restored. In some implementations, the user may generate a three-dimensional restoration instruction for the selected two-dimensional image; the three-dimensional restoration instruction is used for indicating the second position and a restoration shape of the target object; the restoration shape may be understood as a shape of the restored three-dimensional model (the restored model) of the target object, or may be further understood as a size, a placement angle and a shape presented at the placement angle of the restored model in the second position as seen from the current angle of view. It may be understood that during the roaming process, the user may photograph two-dimensional images of a plurality of target objects, and store the obtained two-dimensional images in a specified position; the user will select a target object to be restored from the specified position as needed subsequently, for example, pre-select a two-dimensional image of the target object, and initiate a three-dimensional restoration instruction; then an electronic device configured to execute the model processing method may restore the target object in the second position in the virtual three-dimensional scene, according to the three-dimensional restoration instruction, the photographing parameter and the initial model parameter. The above-described process may be understood as an inverse process of photographing (3D to 2D). For ease of understanding, a placing camera may also be virtually set, and corresponding to the photographing camera for rendering a three-dimensional model into a two-dimensional image, the placing camera is used for restoring the two-dimensional image into the three-dimensional model; in practical applications, the user may perform one or more operations such as a scale operation, a move operation, and a rotate operation on the two-dimensional image; and by processing the two-dimensional image, the placement position and the restoration shape, etc., of the restored model of the target object in the virtual three-dimensional scene may be determined. It may also be understood that when the target object is finally restored to the restored model according to the three-dimensional restoration instruction, the image captured by the placing camera is just the two-dimensional image having undergone the above-described user operations. In some implementations, the initial parameter of the placing camera may be determined based on the foregoing photographing parameter (i.e., the camera parameter of the photographing camera); then some parameters such as focus and focal length, etc., may be further adjusted through user operations based on the initial parameter; and after the user operations, actual parameters such as focus position/focal plane, etc., adopted when the placing camera “places” the restored model may be determined, while parameters having not been adjusted through the user operations still remain the initial photographing parameter. By restoring the focal point position and/or the focal plane, the second position may be further determined, that is, the second position may be determined comprehensively by the three-dimensional restoration instruction and the photographing parameter.

Based on this, the embodiment of the present disclosure provides a generation mode of the three-dimensional restoration instruction; exemplarily, the three-dimensional restoration instruction may be generated according to steps of: when it is monitored that a two-dimensional image stored in the specified position is selected, exhibiting the two-dimensional image in the three-dimensional virtual scene, and obtaining user operations for the two-dimensional image; the user operations including one or more of a scale operation, a move operation, and a rotate operation; and generating the three-dimensional restoration instruction based on the user operations. As described above, it may also be understood as follows: when the user executes a scale operation on a two-dimensional image, the user is actually adjusting a distance of the restored model corresponding to the two-dimensional image relative to the user (or the above-described placing camera); when the user executes a move operation on the two-dimensional image, the user is actually adjusting a position of the restored model corresponding to the two-dimensional image in the virtual three-dimensional scene; and when the user executes a rotate operation on the two-dimensional image, the user is actually adjusting a placement angle or a presentation shape of the restored model corresponding to the two-dimensional image in the virtual three-dimensional scene; the above operations will directly affect the second position and the restoration shape of the restored model to which the target object is finally restored in the virtual three-dimensional scene. When it is not monitored that the user executes a certain operation, it indicates that the corresponding adjustment is not currently being made through the operation; such as, when it is not monitored that the user executes a rotate operation, it indicates that the placement angle or the presentation shape is not adjusted currently, but still remains the initial placement angle or the initial presentation shape. In summary, the user may generate the three-dimensional restoration instruction for indicating the second position of the target object through the above-described operations; and further, the three-dimensional restoration instruction may further indicate the restoration shape of the target object, so as to finally restore the target object into the restored model in the second position following the restoration shape according to the three-dimensional restoration instruction.

The generating the three-dimensional restoration instruction based on a user operation, may be implemented with reference to Step a to Step d as follows:

Step a, when the user operations comprise a move operation, determine a final movement position of the two-dimensional image in the three-dimensional virtual scene according to the move operation. In practical applications, the two-dimensional image is exhibited in the three-dimensional virtual scene, and the user may move the position of the two-dimensional image in the three-dimensional virtual scene, to adjust the position of the restored model corresponding to the two-dimensional image in the virtual three-dimensional scene. In some implementations, the final movement position of the two-dimensional image just corresponds to the above-described second position; in practical applications, the user may move the two-dimensional image directly through a gesture, or may also move the two-dimensional image through an external controller such as a console, or may also move the two-dimensional image through the above-described virtual placing camera; and at this time, the two-dimensional image is just an image displayed on a display interface of the placing camera, and moves with movement of the placing camera.

Step b, when the user operations comprise a rotate operation, determine a final space angle of the two-dimensional image in the three-dimensional virtual scene according to the rotate operation. In practical applications, the two-dimensional image is exhibited in the three-dimensional virtual scene; the user may change the space angle of the two-dimensional image in the virtual three-dimensional scene by rotating the two-dimensional image, so as to adjust an orientation angle for placing the restored model corresponding to the two-dimensional image in the virtual three-dimensional scene. As above, the user may execute the rotate operation on the two-dimensional image through a gesture, an external controller, rotation of the placing camera, etc., and no details will be repeated here.

Step c, when the user operations comprise a scale operation, determine a final size of the two-dimensional image in the three-dimensional virtual scene according to the scale operation. In practical applications, the two-dimensional image is exhibited in the three-dimensional virtual scene; the user may adjust the size of the two-dimensional image in the virtual three-dimensional scene by scaling the two-dimensional image, so as to adjust a distance for placing the restored model corresponding to the two-dimensional image in the virtual three-dimensional scene relative to the current angle of view of the user; it may be understood that the closer the restored model is to the current angle of view of the user, the larger the restored model; and the user may bring the distance closer by zooming in the two-dimensional image, and vice versa. As above, the user may execute the scale operation on the two-dimensional image through a gesture, an external controller, adjustment of the focal length of the placing camera, etc., and no details will be repeated here.

Step d, generate the three-dimensional restoration instruction according to one or more of the determined final movement position, the final space angle, and the final size. Wherein one or more of the final movement position, the final space angle, and the final size may directly affect the second position and the restoration shape. Therefore, the three-dimensional restoration instruction for indicating the second position and the restoration shape may be determined based on one or more of the determined final movement position, the final space angle, and the final size.

It should be understood that the user may execute one or more of the scale operations, the move operation, and the rotate operation as described above on the two-dimensional image; both the scale operation and the move operation will affect the restoration position (the second position) of the restored model of the target object, and the rotate operation will affect the restoration shape; when it is only monitored that the user executes operations such as a move operation and/or a scale operation without executing a rotate operation, it may be considered as adjusting the second position while keeping the restoration shape unchanged; similarly, when it is only monitored that the user executes a rotate operation on the two-dimensional image displayed in the virtual three-dimensional scene, without executing a move operation, it may be considered as adjusting the restoration shape only while keeping the position unchanged. Therefore, even when the user only executes one of the scale operations, the move operation and the rotate operation as described above, the current second position and the current restoration shape of the target object may still be determined.

When the three-dimensional restoration instruction is used for indicating the second position and the restoration shape of the target object, the above-described step of restoring the target object in the second position in the virtual three-dimensional scene, according to the three-dimensional restoration instruction, the photographing parameter, and the initial model parameter include step (1) to step (2) as follows:

Step (1), draw the restored model of the target object by using GPU, according to the restoration shape, the photographing parameter, and the initial model parameter.

In practical applications, the restored model of the target object may be drawn by using GPU Graphics pipeline; in some specific implementation examples, a culling boundary and material parameter of the restored model of the target object may be determined according to the restoration shape, the photographing parameter, and the initial model parameter; wherein the material parameter includes but are not limited to roughness, metalness, reflectivity, etc.; then, the restored model of the target object is drawn by using GPU Shader, based on the culling boundary and the material parameter. Specifically, the photographing parameter may affect a photographing angle range of view of the target object; so an invisible portion of the two-dimensional image outside the view frustum may be determined based on the restoration shape, the photographing parameter, and the initial model parameter and culled based on the culling boundary of the model, and meanwhile, the material parameter at the boundary may be restored, which may effectively prevent face omission while well presenting the restored model of the target object, and present a more accurate and realistic restored model to the user.

Step (2), place the restored model of the target object in the second position in the virtual three-dimensional scene.

Since the restored model of the target object obtained through the above-described inverse process is essentially still an initial model, it may interact normally as other models in the virtual three-dimensional scene. Therefore, the above-described method provided by the embodiment of the present disclosure further comprises: in response to an interaction instruction for the target object located in the second position, executing an operation corresponding to the interaction instruction. An interaction mode may be selected according to actual scenes, and will not be limited here, which may be, for example, a case where the user may open a box, by taking the target object as the box, etc.

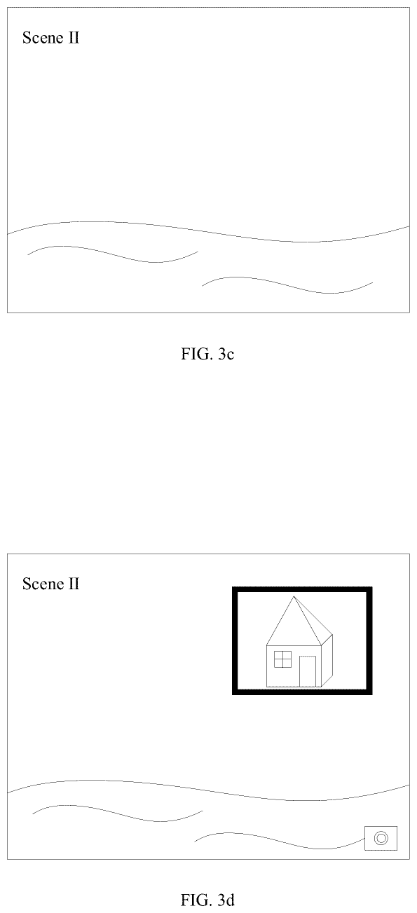

For ease of understanding, it is illustrated in conjunction with FIG. 3a to FIG. 3e; it should be noted that FIG. 3a to FIG. 3e are all schematic diagrams of the virtual three-dimensional scene. FIG. 3a and FIG. 3b represents scene I, showing a house and a plurality of trees; in FIG. 3b, the user takes the house as the target object and obtains a two-dimensional image thereof based on a photographing parameter, which may also be simply understood as photographing the house with a virtual photographing camera to obtain a two-dimensional image, the photographing parameter just being camera parameter. FIG. 3b briefly shows a camera icon in a lower right corner; a black border that frames the house represents a preview picture of the photographing camera, that is, the two-dimensional image obtained by the user through photographing from the angle of view of the photographing camera; through the operation, the two-dimensional image corresponding to the three-dimensional house is obtained, that is, 2D transformation on the 3D model is implemented. The user continues to roam in the virtual three-dimensional scene until the user reaches scene II (corresponding to FIG. 3c to FIG. 3e), wherein FIG. 3c represents that scene II is only a bare riverbank, and FIG. 3d represents the two-dimensional image of the house exhibited in scene II; heretofore, the user might select the two-dimensional image of the house and perform operations such as moving, rotating, and scaling on the two-dimensional image to finally determine the restoration position and the shape of the house in scene II; for simplicity, FIG. 3d only exhibits a finally presented state of the two-dimensional image; heretofore, the user moved and scaled the two-dimensional image to determine the position of the house in the scene, but for simplicity, did not rotate the house so the orientation of the house did not change, which may also be understood as that the shape did not change. It should be noted that the house in scene II looks smaller not because the actual size of the house in scene II is smaller than the actual size of the house in scene I, but because the house in scene I is closer to the user's angle of view, while the house in scene II is farther away from the user's angle of view.

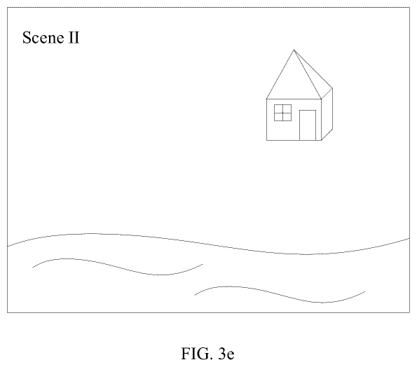

Based on the foregoing, the embodiment of the present disclosure further provides a flow chart of the model processing method; for ease of understanding, a virtual photographing camera is directly introduced in the embodiment of the present disclosure, so that the user may be directly provided with a virtual photographing camera in the virtual three-dimensional scene, to facilitate the user to set photographing parameter by manipulating the photographing camera and project the target object as a two-dimensional image, wherein the camera parameter adopted by the photographing camera when photographing the target object is just the foregoing photographing parameter; specifically, as shown in FIG. 4, the method comprises step S402 to step S414 as follows:

Step S402, in response to a photographing instruction for a target object in a virtual three-dimensional scene, photograph the target object at a specified angle of view through a photographing camera, to obtain a two-dimensional image of the target object.

Step S404, obtain a camera parameter of the target object when the photographing camera obtains the two-dimensional image.

Step S406, obtain a parameter of the three-dimensional model presented by the target object within a photographing angle range of view of the photographing camera through a spatial acceleration structure and/or a view frustum culling mode, and taking the obtained parameter of the three-dimensional model as the initial model parameter of the target object.

Step S418: when it is monitored that the two-dimensional image is selected, exhibit the two-dimensional image in the three-dimensional virtual scene, and obtain user operations for the two-dimensional image; the user operations including one or more of a scale operation, a move operation and a rotate operation;

Step S410, generate the three-dimensional restoration instruction for indicating the restoration position and the restoration shape based on the user operations, and render the restored model of the target object through GPU drawing according to the three-dimensional restoration instruction, the camera parameter, and the initial model parameter, wherein the restoration position is just the foregoing second position.

Step S414, in response to an interaction instruction for the target object, execute an operation corresponding to the interaction instruction.

It should be understood that the above steps are only an implementation example based on the foregoing model processing method and should not be considered as a limitation; in practical applications, fewer or more steps than the above steps may be included; the foregoing relevant content may be referred to for specific implementation of the above-described steps, and no details will be repeated here.

In summary, as compared with model reconstruction in related technologies by using a neural network model which is time-consuming, inefficient, and has low accuracy, in the above-described model processing method provided by the embodiment of the present disclosure, the existing 3D model may undergo 2D transformation (i.e., be transformed into an image), and further the image is inversely restored to the 3D model based on the camera parameter and the initial model parameter, so that rapid and efficient model restoration may be performed on an interested target object in different positions. In addition, based on the camera parameter and the initial model parameter already existing, inverse restoration may be implemented through GPU drawing, which fully utilizes the modes such as the 3D spatial structure, GPU culling, and boundary drawing, etc., to effectively ensure model restoration accuracy and visual effects. In addition, as compared with related technologies of poor flexibility in which reconstruction is only applicable to a 3D model under a fixed angle of view corresponding to an existing picture, the above-described model processing method provided by the embodiment of the present disclosure may allow the user to flexibly select an interested target object according to needs, to photograph an image thereof from an arbitrary angle of view, and to perform model restoration, which is more flexible and unrestricted. Besides, it should be understood that the target object is not a fixed article whose type is pre-specified, and the embodiment of the present disclosure is not simply intended to move the object position, but to photograph and render a picture within any angle of view (which is also constituted by a three-dimensional virtual model within the angle of view, and may be collectively referred to as the target object) in the virtual three-dimensional scene, and then flexibly and efficiently restore according to needs, through records such as two-dimensional data such as the camera parameter as well as the initial model parameter.

The above-described model processing method provided by the embodiment of the present disclosure may be applied to, but not limited to, traditional 3D games, AR, and VR, and may also be applied to any application such as product exhibition, digital city, etc., that uses 2D pictures/3D models for transformation and interaction.

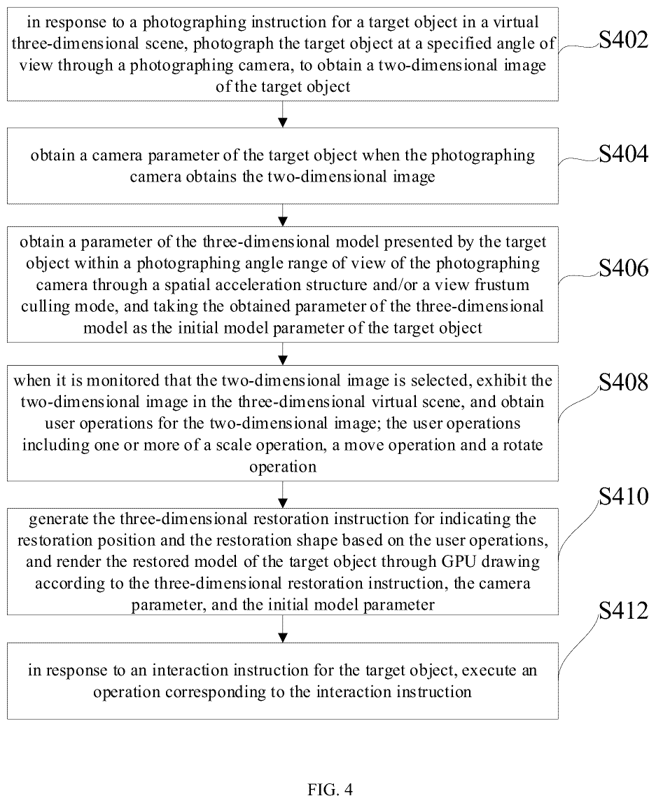

Correspondingly to the foregoing model processing method, an embodiment of the present disclosure further provides a model processing apparatus; FIG. 5 is a structural schematic diagram of a model processing apparatus provided by an embodiment of the present disclosure; the apparatus may be implemented through software and/or hardware and may usually be integrated into an electronic device; and as shown in FIG. 5, the model processing apparatus 500 mainly comprises:
An image obtaining module 502, configured to: in response to a photographing instruction for a target object in a virtual three-dimensional scene, obtain a two-dimensional image of the target object, and store the two-dimensional image in a specified position; wherein the target object is a three-dimensional model located in a first position in the virtual three-dimensional scene;
A parameter obtaining module 504, configured to: obtain an initial model parameter of the target object;
A restoring module 506, configured to: in response to a three-dimensional restoration instruction for the two-dimensional image stored in the specified position, restore the target object in a second position in the virtual three-dimensional scene, according to the three-dimensional restoration instruction and the initial model parameter; wherein the three-dimensional restoration instruction is used for indicating the second position.

The above-described model processing apparatus provided by the embodiment of the present disclosure may perform 2D transformation on an existing 3D model (i.e., transform the 3D model into an image), and further inversely restore the image to the 3D model based on the three-dimensional restoration instruction and the initial model parameter, so as to perform rapid and efficient model restoration on an interested target object in different positions. In addition, based on the existing initial model parameter, the above-described inverse restoration process may effectively ensure model restoration accuracy. Besides, the user may flexibly select an interested target object according to needs and may photograph an image thereof and perform model restoration from an arbitrary angle of view, with more flexibility and freedom, which further improves the problems in related technologies such as poor flexibility that reconstruction is only applicable to a 3D model under a fixed angle of view corresponding to an existing picture.

In some implementations, the image obtaining module 502 is specifically configured to: perform a two-dimensional projection on the target object according to a specified photographing parameter, to obtain the two-dimensional image of the target object.

In some implementations, the parameter obtaining module 504 is specifically configured to: obtain a parameter of the three-dimensional model presented by the target object within a photographing angle range of view corresponding to the photographing parameter, through a spatial acceleration structure and/or a view frustum culling mode; and take the obtained parameter of the three-dimensional model as the initial model parameter of the target object.

In some implementations, the restoring module 506 is specifically configured to: restore the target object in the second position in the virtual three-dimensional scene, according to the three-dimensional restoration instruction, the photographing parameter, and the initial model parameter.

In some implementations, the three-dimensional restoration instruction is further used for indicating a restoration shape of the target object.

In some implementations, the apparatus further comprises an instruction generating module, configured to generate the three-dimensional restoration instruction according to steps of:
when it is monitored that the two-dimensional image stored in the specified position is selected, exhibiting the two-dimensional image in the three-dimensional virtual scene, and obtaining user operations for the two-dimensional image; the user operations including one or more of a scale operation, a move operation, and a rotate operation; and
generating the three-dimensional restoration instruction based on the user operations.

In some implementations, the instruction generating module is specifically configured to: when the user operations comprise a move operation, determine a final movement position of the two-dimensional image in the three-dimensional virtual scene according to the move operation; when the user operations comprise a rotate operation, determine a final space angle of the two-dimensional image in the three-dimensional virtual scene according to the rotate operation; when the user operations comprise a scale operation, determine a final size of the two-dimensional image in the three-dimensional virtual scene according to the scale operation; and generate the three-dimensional restoration instruction according to one or more of the final movement position, the final space angle, and the final size determined.

In some implementations, the restoring module 506 is specifically configured to: draw a restored model of the target object by using GPU according to the restoration shape, the photographing parameter, and the initial model parameter; and place the restored model of the target object in the second position in the virtual three-dimensional scene.

In some implementations, the restoring module 506 is specifically configured to: determine a culling boundary and material parameter of the restored model of the target object, according to the restoration shape, the photographing parameter, and the initial model parameter; and draw the restored model of the target object by using GPU Shader, based on the culling boundary and the material parameter.

In some implementations, the method further comprises: an interacting module, configured to: in response to an interaction instruction for the target object located in the second position, execute an operation corresponding to the interaction instruction.

The model processing apparatus provided by the embodiment of the present disclosure may execute the model processing method provided by any embodiment of the present disclosure and has corresponding functional modules and advantageous effects for executing the method.

Those skilled in the art may clearly understand that for convenience and conciseness of description, the corresponding process in the method embodiment may be referred to as the specific operation process of the apparatus embodiment as described above, and no details will be repeated here.

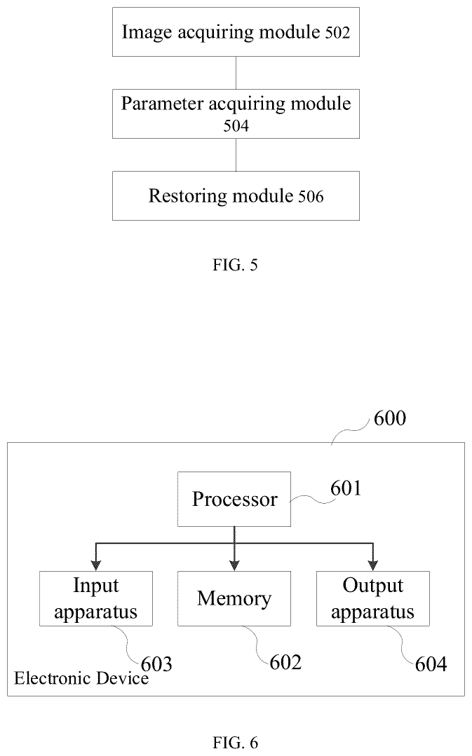

An embodiment of the present disclosure further provides an electronic device, including a processor; and a memory, configured to store processor executable instructions; wherein the processor is configured to read the executable instructions from the memory and execute the instructions to implement the model processing method according to any one of the above-described items. FIG. 6 is a structural schematic diagram of an electronic device provided by an embodiment of the present disclosure. As shown in FIG. 6, the electronic device 600 comprises one or more processors 601 and memories 602.

The processor 601 may be a Central Processing Unit (CPU) or other form of processing unit with a data processing capability and/or an instruction execution capability; and may control other components in the electronic device 600 to execute desired functions.

The memory 602 may include one or more computer program products, and the computer program products may include various forms of computer readable storage media, for example, a volatile memory and/or a non-volatile memory. The volatile memory may include, for example, a Random Access Memory (RAM) and/or a cache, or the like. The non-volatile memory may include, for example, a Read Only Memory (ROM), a hard disk, a flash memory, or the like. One or more computer program instructions may be stored on the computer readable storage medium, and the processor 601 may run the program instructions, to implement the model processing method and/or other desired functions according to the embodiments of the present disclosure as described above. Various contents such as input signals, signal components, noise components, etc., may also be stored on the computer readable storage medium.

In one example, the electronic device 600 may further include: an input apparatus 603 and an output apparatus 604; and these components are interconnected through a bus system and/or other forms of connection mechanisms (not shown).

In addition, the input apparatus 603 may further include, for example, a keyboard, a mouse, or the like.

The output apparatus 604 may output various information to the outside, including determined distance information, direction information, etc. The output apparatus 604 may include, for example, a display, a speaker, a printer, a communication network, and a remote output apparatus connected therewith.

Of course, for simplicity, only some of the components related to the present disclosure in the electronic device 600 are shown in FIG. 6, and components such as a bus, an input/output interface, etc., are omitted. In addition, according to specific application situations, the electronic device 600 may further include any other appropriate components. In addition to the above-described method and device, an embodiment of the present disclosure may further be a computer program product, including computer program instructions; and the computer program instructions, when run by a processor, cause the processor to execute the model processing method provided by the embodiment of the present disclosure.

The computer program product may write the program codes for executing the operations according to the embodiment of the present disclosure in any combination of one or more programming languages; the above-described programming languages include object-oriented programming languages such as Java, C++, etc., and also include conventional procedural programming languages such as “C” language or similar programming languages. The program code may execute entirely on the user's computer, partly on the user's computer, as a stand-alone software package, partly on the user's computer and partly on a remote computer or entirely on the remote computer or server.

In addition, an embodiment of the present disclosure may further be a computer readable storage medium, having computer program instructions stored thereon; wherein the computer program instructions, when run by a processor, cause the processor to execute the model processing method provided by the embodiment of the present disclosure.

The computer readable storage medium may adopt any combination of one or more readable media. The readable medium may be a readable signal medium or a readable storage medium. The readable storage medium may be, for example, but not limited to, an electronic, magnetic, optical, electromagnetic, infrared, or semiconductor system, apparatus, or device, or any suitable combination of the above. More specific examples of the readable storage medium (non-exhaustive list) include an electrical connection having one or more conductors, a portable computer diskette, a hard disk, a Random Access Memory (RAM), a Read-Only Memory (ROM); an Erasable Programmable Read-Only Memory (EPROM or flash memory); an optical fiber, a portable Compact Disc Read-Only Memory (CD-ROM); an optical storage device; a magnetic storage device; or any suitable combination of the above.

An embodiment of the present disclosure further provides a computer program product, including computer programs/instructions, wherein the computer programs/instructions, when executed by a processor, implement the model processing method according to the embodiment of the present disclosure.

It should be noted that in this paper, relational terms such as “first” and “second” are only used to distinguish one entity or operation from another entity or operation, and do not necessarily require or imply that there is any such actual relationship or order between these entities or operations. Moreover, the terms “including”, “comprising” or any other variation thereof are intended to cover non-exclusive inclusion, so that a process, a method, an object, or a device including a series of elements includes not only those elements but also other elements not explicitly listed or elements inherent to such process, method, article or equipment. Without further restrictions, an element defined by the phrase “including one . . . ” does not exclude the existence of other identical elements in the process, the method, the object or the device including the element.

What has been described above is only the specific embodiment of the present disclosure, so that those skilled in the art can understand or realize the present disclosure. Many modifications to these embodiments will be obvious to those skilled in the art, and the general principles defined herein can be implemented in other embodiments without departing from the spirit or scope of this disclosure. Therefore, this disclosure will not be limited to the embodiments described herein, but is to be accorded the widest protection scope consistent with the concepts and novel features disclosed herein.

The invention claimed is:

1. A model processing method, comprising:
in response to a photographing instruction for a target object in a virtual three-dimensional scene, obtaining a two-dimensional image of the target object, and storing the two-dimensional image in a specified position; wherein the target object is a three-dimensional model located in a first position in the virtual three-dimensional scene;
obtaining an initial model parameter of the target object; and
in response to a three-dimensional restoration instruction for the two-dimensional image stored in the specified position, restoring the target object in a second position in the virtual three-dimensional scene according to the three-dimensional restoration instruction and the initial model parameter, and wherein the three-dimensional restoration instruction is used for indicating the second position.

2. The method of claim 1, wherein the step of obtaining the two-dimensional image of the target object, comprises:
performing a two-dimensional projection on the target object according to a specified photographing parameter, to obtain the two-dimensional image of the target object.

3. The method of claim 2, wherein the step of obtaining the initial model parameter of the target object, comprises:
obtaining a parameter of a three-dimensional model presented by the target object within a photographing angle range of view corresponding to the photographing parameter, through a spatial acceleration structure and/or a view frustum culling mode; and taking the obtained parameter of the three-dimensional model as the initial model parameter of the target object.

4. The method of claim 2, wherein the step of restoring the target object in the second position in the virtual three-dimensional scene according to the three-dimensional restoration instruction and the initial model parameter, comprises:
restoring the target object in the second position in the virtual three-dimensional scene according to the three-dimensional restoration instruction, the photographing parameter, and the initial model parameter.

5. The method of claim 1, wherein the three-dimensional restoration instruction is further used for indicating a restoration shape of the target object.

6. The method of claim 1, wherein the three-dimensional restoration instruction is generated according to steps of:
when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and
generating the three-dimensional restoration instruction based on the user operations.

7. The method of claim 6, wherein the step of generating the three-dimensional restoration instruction based on the user operations, comprises:
when the user operations comprise the move operation, determining a final movement position of the two-dimensional image in the three-dimensional virtual scene according to the move operation;
when the user operations comprise the rotate operation, determining a final space angle of the two-dimensional image in the three-dimensional virtual scene according to the rotate operation;
when the user operations comprise the scale operation, determining a final size of the two-dimensional image in the three-dimensional virtual scene according to the scale operation; and
generating the three-dimensional restoration instruction according to one or more of the determined final movement position, the final space angle, and the final size.

8. The method of claim 5, wherein the step of restoring the target object in the second position in the virtual three-dimensional scene, according to the three-dimensional restoration instruction, the photographing parameter, and the initial model parameter, comprises:
drawing a restored model of the target object by using GPU, according to the restoration shape, the photographing parameter, and the initial model parameter; and
placing the restored model of the target object in the second position in the virtual three-dimensional scene.

9. The method of claim 8, wherein the step of drawing a restored model of the target object by using GPU, according to the restoration shape, the photographing parameter, and the initial model parameter, comprises:
determining a culling boundary and material parameter of the restored model of the target object, according to the restoration shape, the photographing parameter, and the initial model parameter; and
drawing the restored model of the target object by using GPU Shader based on the culling boundary and the material parameter.

10. The method of claim 1, further comprising:
in response to an interaction instruction for the target object located in the second position, executing an operation corresponding to the interaction instruction.

11. (canceled)

12. An electronic device, comprising:
at least one processor;
a memory, configured to store processor executable instructions; and
the at least one processor, configured to read the executable instructions from the memory, and execute the instructions to implement a model processing method, wherein the model processing method comprises:
in response to a photographing instruction for a target object in a virtual three-dimensional scene, obtaining a two-dimensional image of the target object, and storing the two-dimensional image in a specified position; wherein the target object is a three-dimensional model located in a first position in the virtual three-dimensional scene;
obtaining an initial model parameter of the target object; and
in response to a three-dimensional restoration instruction for the two-dimensional image stored in the specified position, restoring the target object in a second position in the virtual three-dimensional scene according to the three-dimensional restoration instruction and the initial model parameter, and wherein the three-dimensional restoration instruction is used for indicating the second position.

13. A non-volatile computer readable storage medium, having a computer program stored thereon, wherein the computer program is configured to execute a model processing method according to claim 1.

14. The method of claim 2, wherein the three-dimensional restoration instruction is generated according to steps of:
when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and
generating the three-dimensional restoration instruction based on the user operations.

15. The method of claim 3, wherein the three-dimensional restoration instruction is generated according to steps of:
when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and
generating the three-dimensional restoration instruction based on the user operations.

16. The method of claim 4, wherein the three-dimensional restoration instruction is generated according to steps of:
when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and
generating the three-dimensional restoration instruction based on the user operations.

17. The method of claim 5, wherein the three-dimensional restoration instruction is generated according to steps of:
when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and
generating the three-dimensional restoration instruction based on the user operations.

18. The electronic device of claim 12, wherein the step of obtaining the two-dimensional image of the target object, comprises:
performing a two-dimensional projection on the target object according to a specified photographing parameter, to obtain the two-dimensional image of the target object.

19. The electronic device of claim 18, wherein the step of obtaining the initial model parameter of the target object, comprises:
obtaining a parameter of a three-dimensional model presented by the target object within a photographing angle range of view corresponding to the photographing parameter, through a spatial acceleration structure and/or a view frustum culling mode; and taking the obtained parameter of the three-dimensional model as the initial model parameter of the target object.

20. The electronic device of claim 18, wherein the step of restoring the target object in the second position in the virtual three-dimensional scene according to the three-dimensional restoration instruction and the initial model parameter, comprises:
restoring the target object in the second position in the virtual three-dimensional scene according to the three-dimensional restoration instruction, the photographing parameter, and the initial model parameter.

21. The electronic device of claim 12, wherein the three-dimensional restoration instruction is generated according to steps of:
when it is monitored that the two-dimensional image stored in the specified position is selected, exhibiting the two-dimensional image in the three-dimensional virtual scene, and obtaining user operations for the two-dimensional image; the user operations comprising one or more of a scale operation, a move operation, and a rotate operation; and
generating the three-dimensional restoration instruction based on the user operations.
